(19) United States
(12) Patent Application Publication
(10) Pub. No.: US 2016/0246758 A1
(43) Pub. Date: Aug. 25, 2016

(54) METHOD AND SYSTEM OF PROCESSING EMAIL MESSAGES CONTAINING CITED TEXT

(71) Applicant: YANDEX EUROPE AG, Luzern (CH)

(72) Inventors: Andrei Igorevich SUNDIEV, Moscow (RU); Anton Andreevich TURSENEV, Vakhrushi Village, Kirov Region (RU); Egor Vladimirovich GANIN, Podolskiy District, Moscow Region (RU)

(21) Appl. No.: 15/028,062

(22) PCT Filed: Dec. 2, 2014
(86) PCT No.: PCT/IB2014/066525

§ 371 Date: Apr. 8, 2016

(30) Foreign Application Priority Data
Sep. 30, 2014 (RU) 2014139482

(51) Int. Cl. G06F 17/21; G06F 17/22; H04L 29/08

(52) U.S. Cl. CPC G06F 17/212; H04L 67/02; G06F 17/2247

(57) ABSTRACT

System and method for computer processing of email messages and visual presentation of citations in the body of the email message, the system and method involving: the finding of the first header of the first citation connected to the forwarded first email message; comparing at least part of the first header of the first citation with a set of masks and determining data from the first header of the first citation; finding the second header of the second citation connected to the forwarded second email message; comparing at least part of the second header of the second citation with a set of masks and determining data from the second header of the second citation; generating the presentation of the email message in which data from at least part of the first header of the first citation and data from at least part of the second header of the second citation are accordingly presented in unified format.

### CROSS-REFERENCE

The present application claims convention priority to Russian Patent Application No. 2014139482, filed Sep. 30, 2014, entitled “ [symbol] [symbol] [symbol] [symbol] [symbol] [symbol] [symbol] [symbol] [symbol] [symbol] ” which is incorporated by reference herein in its entirety.

### FIELD OF TECHNOLOGY

The present technology relates to a system and method of processing email messages containing cited text.

### PRIOR ART

In modern-day computer technologies the use of email has become very widespread.

For the sending of email messages, users can make use of the various email services, such as Yandex.Mail, Google mail, Hotmail, Yahoo!Mail, iCloud Mail, Web.de and others offered by different providers.

For the sending of email messages, users can make use of various mail clients, that is, software installed on the user's client device and designed to receive, sign, send and save email messages of one or more users (for example, in the case of several account records on a single computer) or several account records of the same user. As an example of mail clients, one can mention Microsoft Outlook™, The Bat! ™ Mozilla Thunderbird™, Opera™ Mail, Windows™ Mail, Lotus Notes™, The Bee™, Apple™ Mail, Evolution™, Sylpheed™, Lotus Notes™, and others.

For the sending of email messages, users can also make use of a web interface, which can be an application used on a mail server.

The sending of email messages can be done from various client devices. For example, the sending of messages can be done from smartphones, that is, mobile telephones supplemented with the functionality of a personal pocket computer. The sending of email messages can also be done from stationary computers and notebooks of various manufacturers and under the control of various operating systems.

An email message generally consists of two parts: (a) an email message header and (b) the body of the email message.

The email message header can contain information concerning the sender, the recipients, the date of sending, the time of sending, and other information.

The precise content of the email message header differs according to the email system which has formulated the message.

The form of presentation of header data (such as the date and time of sending the message) in the email message may also differ.

Furthermore, the user of an email service may obtain an email message and then forward it. The message received by the end user will contain an email message header. However, this email message header will contain information on the end email message and not always contain complete information regarding the first (original) email message.

The form of presentation in an email message of data such as the date and time of sending of messages embedded as citations in the email message may also differ.

Thus, while the existing ordinary computer systems are adequate, still an improvement of these systems is possible.

### SUMMARY

The aim of the present technology is to eliminate or mitigate at least some of the inconveniences present in the current prior art.

In accordance with a broad aspect of the present technology, there is provided a method. The method is for computer processing of email messages and visual presentation in the body of the email message of citations constituting a sequence of content of a first forwarded email message and the content of a second forwarded email message, the method involving the finding of the first header of the first citation connected to the forwarded first email message; comparing at least part of the first header of the first citation with a set of masks and determining data from the first header of the first citation; finding the second header of the second citation connected to the forwarded second email message; comparing at least part of the second header of the second citation with a set of masks and determining data from the second header of the second citation; generating the presentation of the email message in which data from at least part of the first header of the first citation and data from at least part of the second header of the second citation are presented in a unified format.

In certain variant embodiments of the technology, the method further comprises obtaining the email message source code.

In certain variant embodiments of the technology, where the email message source code has an HTML markup, the method further comprises finding the first HTML tags describing the first citation, and finding the second HTML tags describing the second citation.

In certain variant embodiments of the technology, the determining of data from at least part of the first header of the first citation further comprises determining the first email address; and the determining of data from at least part of the second header of the second citation further comprises determining the second email address.

In certain variant embodiments of the technology, the determining of data from at least part of the first header of the first citation further comprises determining the date of sending of the first email message; and the determining of data from at least part of the second header of the second citation further comprises determining the date of sending of the second email message.

In certain variant embodiments of the technology, the determining of data from at least part of the first header of the first citation further comprises determining the time of sending of the first email message; and the determining of data from at least part of the second header of the second citation further comprises determining the time of sending of the second email message.

In certain variant embodiments of the technology, the determining of data from at least part of the first header of the first citation further comprises determining the name of the sender of the first email message; and the determining of data from at least part of the second header of the second citation further comprises determining the name of the sender of the second email message.

In certain variant embodiments of the technology, the determining of data from at least part of the first header of the first citation further comprises determining the data from the first fragment of HTML code immediately adjacent to the first HTML tag pertaining to the first citation, and the determining of data from the second header of the second citation further comprises determining data from the second fragment of HTML code immediately adjacent to the second HTML tag pertaining to the second citation.

In certain variant embodiments of the technology, (i) the first fragment of HTML code immediately adjacent to the first HTML tag pertaining to the first citation includes at least one of: a portion of HTML code immediately preceding the first HTML tag pertaining to the first citation, and a portion of HTML code immediately following the first HTML tag pertaining to the first citation, and (ii) the second fragment of HTML code immediately adjacent to the second HTML tag pertaining to the second citation includes at least one of: a portion of HTML code immediately preceding the second HTML tag pertaining to the second citation, and a portion of HTML code immediately following the second HTML tag pertaining to the second citation.

In certain variant embodiments of the technology, (i) the portions of HTML code immediately preceding, respectively, one of: the HTML tag pertaining to the first citation and the HTML tag pertaining to the second citation, are situated at a distance of within four lines from the opening HTML tags of, respectively, the first header of the first citation and the second header of the second citation, and where (ii) the portions of HTML code immediately following, respectively, one of: the HTML tag pertaining to the first citation and the HTML tag pertaining to the second citation, are situated at a distance of within four lines from the opening HTML tags of, respectively, the first header of the first citation and the second header of the second citation.

In certain variant embodiments of the technology, the first citation has been sent as a first email message with the use of a first mail service, and the second citation has been sent as a second email message with the use of a second mail service.

In certain variant embodiments of the technology, the first citation has been sent as a first email message with the use of a first web browser, and the second citation has been sent as a second email message with the use of a second web browser.

In certain variant embodiments of the technology, the method further includes obtaining a first avatar of the author of the first citation and a second avatar of the author of the second citation, and including the first avatar and the second avatar in unified format in the body of the email message.

In certain variant embodiments of the technology, the method further includes: (i) finding the first email message header; (ii) determining data from the first email message header; (iii) generating a presentation of the email message, in which data from the email message header, data from at least part of the first header of the first citation, and data from at least part of the second header of the second citation are presented in unified format.

In accordance with another broad aspect of the present technology, there is provided a computer. The computer comprises a processor. The processor is configured to: find the first header of a first citation connected to a forwarded first email message; compare at least a portion of the first header of the first citation with a set of masks and determine data from the first header of the first citation; find the second header of a second citation connected to a forwarded second email message; compare at least a portion of the second header of the second citation with a set of masks and determine data from the second header of the second citation; form a presentation of the email message, in which data from at least part of the first header of the first citation and data from at least part of the second header of the second citation are respectively presented in unified format.

In certain variant embodiments of the technology, the processor is further configured to obtain the source code of the email message.

In certain variant embodiments of the technology, where the source code of the email message has an HTML, markup, the computer further finds the first HTML tags describing the first citation and the second HTML tags describing the second citation.

In certain variant embodiments of the technology, the determining of data from at least part of the first header of the first citation further comprises determining the first email address, and the determining of data from at least part of the second header of the second citation further comprises determining the second email address.

In certain variant embodiments of the technology, the determining of data from at least part of the first header of the first citation further comprises determining the date of sending of the first email message, and the determining of data from at least part of the second header of the second citation further comprises determining the date of sending of the second email message.

In certain variant embodiments of the technology, the determining of data from at least part of the first header of the first citation further comprises determining the time of sending of the first email message; and the determining of data from at least part of the second header of the second citation further comprises determining the time of sending of the second email message.

In certain variant embodiments of the technology, the determining of data from at least part of the first header of the first citation further comprises determining the name of the sender of the first email message; and the determining of data from at least part of the second header of the second citation further comprises determining the name of the sender of the second email

In certain variant embodiments of the technology, the determining of data from at least part of the first header of the first citation further comprises determining data from the first fragment of HTML code immediately adjacent to the first HTML tag pertaining to the first citation, and the determining of data from the second header of the second citation further comprises determining data from the second fragment of HTML code immediately adjacent to the second HTML tag pertaining to the second citation.

In certain variant embodiments of the technology, (i) the first fragment of HTML code immediately adjacent to the first HTML tag pertaining to the first citation includes at least one of: a portion of HTML code immediately preceding the first HTML tag pertaining to the first citation, and a portion of HTML code immediately following the first HTML tag pertaining to the first citation, and (ii) the second fragment of HTML code immediately adjacent to the second HTML tag pertaining to the second citation includes at least one of: a portion of HTML code immediately preceding the second HTML tag pertaining to the second citation, and a portion of HTML code immediately following the second HTML tag pertaining to the second citation.

In certain variant embodiments of the technology, (i) the portions of HTML code immediately preceding, respectively, one of: the HTML tag pertaining to the first citation and the HTML tag pertaining to the second citation, are situated at a distance of within four lines from the opening HTML tags of, respectively, the first header of the first citation and the second header of the second citation, and where (ii) the portions of HTML code immediately following, respectively, one of: the HTML tag pertaining to the first citation and the HTML tag pertaining to the second citation, are situated at a distance of within four lines from the opening HTML tags of, respectively, the first header of the first citation and the second header of the second citation.

In certain variant embodiments of the technology, the first citation has been sent as a first email message with the use of a first mail service, and the second citation has been sent as a second email message with the use of a second mail service.

In certain variant embodiments of the technology, the first citation has been sent as a first email message with the use of a first web browser, and the second citation has been sent as a second email message with the use of a second web browser.

In certain variant embodiments of the technology, the first citation has been sent as a first email message with the use of a first mail client, and the second citation has been sent as a second email message with the use of a second mail client.

In certain variant embodiments of the technology, the computer further obtains a first avatar of the author of the first citation and a second avatar of the author of the second citation, and includes the first avatar and the second avatar in the unified format in the body of the email message.

In certain variant embodiments of the technology, the computer further: (i) finds the first header of the email message; (ii) computes data from the first header of the email message; (iii) forms a presentation of the email message in which data from the email message header, data from at least part of the first header of the first citation, and data from at least part of the second header of the second citation are presented in the unified format.

In the context of the specification of the present technology, “server” is a program executed on corresponding equipment and capable of receiving requests (for example, those sent by client devices) which are transmitted by a network, and of fulfilling these requests or arranging for their fulfillment. Equipment can be one computer or one computer system, although neither is mandatory in regard to the proposed technology. In a given context, the phrase “at least one server” does not mean that each task (such as the task represented by the received instructions or requests) or some particular task will be received, executed, or arranged to be executed by the same server (that is, the same software and/or hardware); it is assumed that the reception and transmission, the fulfillment or arranging for the fulfillment of any task or request or the processing of the results of a task or request can be done by any given number of software components or devices and all these software or hardware components can be represented by a single server or several servers, while the phrase “at least one server” covers both of these variants.

In the context of the specification of the present technology, “client device” is any computer equipment making it possible to execute software designed to handle the requested task. In the context of the present specification, the term “client device” is basically associated with the user of a client device. Some (not exhaustive) examples of client devices include personal computers (desktop computers, portable computers, netbooks, and so on), smartphones and tablets, as well as network hardware, such as routers, switches and gateways. It should be noted in this context that the fact that a device is functioning as a client device does not rule out its possible functioning as a server for other client devices. The use of the term “client device” does not prevent the use of several client and/or electronic devices in the process of receiving and transmitting, executing or arranging for the execution of a task or request or the processing of the results of a task or request or the steps of the method presented in this specification.

In the context of the specification of the present technology, “source code” is the text of a computer program in any given programming language or markup language which can be read by a human being. In a generalized sense, source code is any input data for a translator. Source code is translated into executable code in its entirety before running a program by means of a compiler, or it can be executed at once by means of an interpreter.

In the context of the specification of the present technology, the term “information” includes information of any given nature or type. Thus, information encompasses, among other things, audiovisual information (images, films, sound recordings, presentations, and so on), data (location data, numerical data, and so on), text information (statements, comments, questions, messages, and so on), documents, spreadsheets, and so on.

In the context of the specification of the present technology, the term “software component” encompasses software (corresponding to particular hardware) which is at the same time necessary and sufficient to the execution of a particular indicated function(s).

In the context of the specification of the present technology, the term “email message” includes a file formed by a sender and intended for transmission to one or more recipients by email. An email message can comprise two parts: an email message header (which, in turn, can include records), and an email message body.

In the context of the specification of the present technology, the term “citation header” covers text in the body of an email message, while the email message contains a citation, and the indicated text refers to the indicated citation. The citation header is not an email message header.

In the present specification, the term “information storage medium intended for use by a computer” (also “information storage medium” for short) encompasses storage media of any given nature and type, including RAM, ROM, disks (compact disks, DVD disks, floppy disks, hard disks, and so on), USB keys, solid state drives, tape drives, and so on.

In the present specification the words “first”, “second”, “third” and so on are used only as descriptive elements for purposes of separating substantives which are different from each other and not for the purpose of determining some particular relationship between these substantives. Thus, for example, it should be understood that the terms “first server” and “third server” do not signify the introducing of a particular sequence, type, chronology, hierarchy or ranking (for example) of a particular server or several servers, and their use (in itself) does not mean that in some particular situation there must necessarily exist a “second server”. Furthermore, as indicated in the present specification with regard to other examples of implementing the technology, a reference to “first” element and “second” element does not signify that the two elements cannot in fact constitute the same element in the real world. Thus, for example, in certain cases a “first” server and “second” server may constitute the same software and/or hardware component, and in other situations they may be realized in different software and/or hardware.

Each embodiment of the technology has at least one of the aforementioned goals and/or one of the aforementioned aspects, but not necessarily all of them. It should be kept in mind that certain aspects of the present technology which have resulted from an attempt to achieve the aforementioned goal may not achieved that goal and/or may achieve other goals not especially mentioned herein.

Additional and/or alternative features, goals, aspects and benefits of the given technology will become clear from the following description, accompanied by the drawings and the enclosed set of claims.

### BRIEF DESCRIPTION OF THE DRAWINGS

For a better understanding of the present technology, as well as its other aspects and features, one should refer to the following specification, which should be used together with the appended drawings, in which:

FIG. 1 is a schematic representation of one embodiment of a network computer system 100, realizing the present technology.

FIG. 2 is a schematic representation of an email message structure.

FIG. 3 is an example of an email message, which body contains three citations, on the display of a client device, implemented in accordance with prior art techniques.

FIG. 4 is an example of an email message, formulated in accordance with one embodiment of the present technology, whose body contains three citations, on the display of a client device.

FIG. 5 is a block diagram of the method, being carried out on the mail server of FIG. 1, and carried out in accordance with non-limiting embodiments of the present technology.

### DETAILED DESCRIPTION

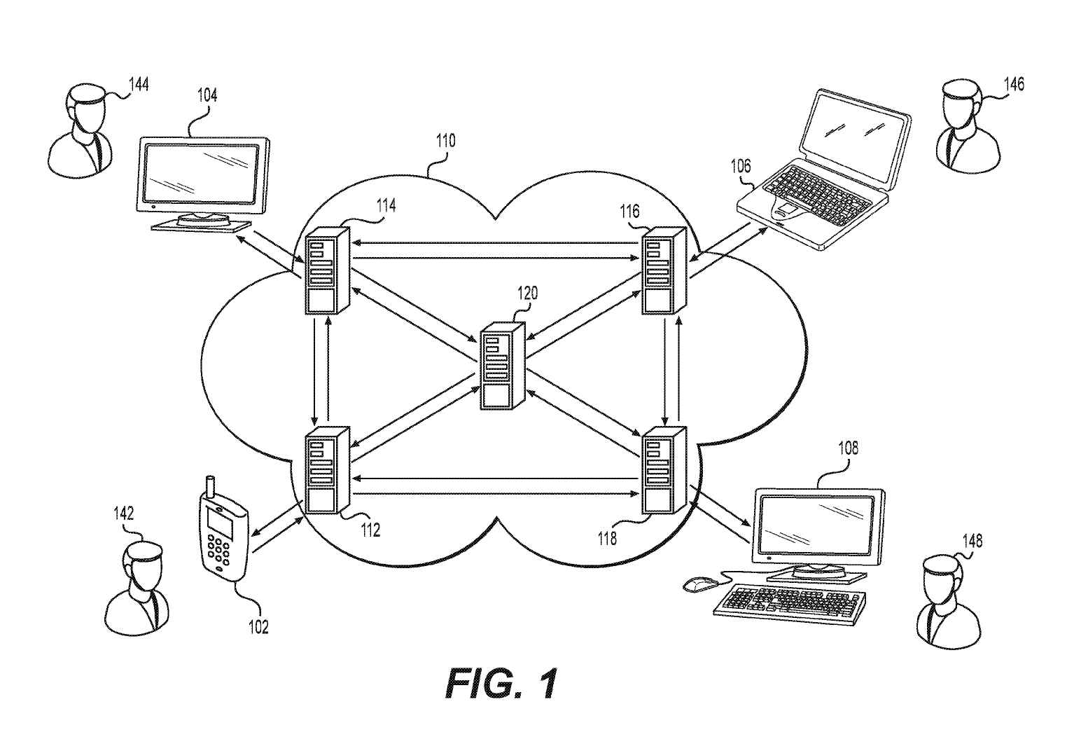

FIG. 1 shows a basic diagram of a network computer system 100, whose components are linked to one another with the aid of a data communication network 110.

It is important to keep in mind that the network computer system 100 is presented as an embodiment of the present technology. Thus, the following specification should be viewed solely as a description of examples of the present technology. This specification is not intended to define the scope or establish the limits of the present technology. Several useful examples of modifications of the computer system 100 can also be subsumed under the following description. The aim of this description is solely to help in the understanding, and not to define the scope and limits of the present technology. These modifications do not constitute an exhaustive list, and the persons skilled in the art will understand that other modifications are also possible. Furthermore, this should not be interpreted in the sense that no modifications are possible where such has not been done, i.e., where no examples of modifications have been presented, or that what is specified is the only way of implementing this element of the given technology. As will be clear to the person skilled in this art, such is more likely not the case. Furthermore, it should be kept in mind that the computer system 100 in certain specific configurations is a rather simple embodiment of the present technology, and in such instances it has been presented here in order to facilitate understanding. As will be clear to the person skilled in the art, many variant embodiments of the present technology will have much greater complexity.

The computer system 100 includes a client device 102. The client device 102 is usually associated with the user 142.

It should be noted that the fact that the client device 102 is associated with the user 142 does not imply any specific operating mode of the client device 102.

The client device 102 is realized in the form of a smartphone Apple iPhone 5S with installed operating system iOS 7 running on it, with Bluetooth, Wi-Fi, 3G, LTE, and GPS positioning system.

The client device 102 also includes an information storage medium (not shown). In principle, such an information storage medium can be of absolutely any nature or type, including RAM, ROM, disks (compact disks, DVDs, diskettes, hard disks, and so on), USB flash drives, solid state drives, magnetic tape drives, and so on, as well as combinations of these. In the client device 102 depicted in FIG. 1, the information storage medium is realized as a flash drive with volume of 16 GB.

The information storage medium can store user files and program instructions. In particular, the information storage medium can store software realizing a mail client. In the general case, the purpose of a mail client is to afford the possibility of sending and receiving email messages to the user 142. As an example, not limited to this, such mail clients can be Mailbox™, Triage™, Evomail™, Dispatch™, Inky™ Mail, Seed™, myMail™, Boxer™ and others. In the client device 102, the mail client is realized as Triage. It is important to keep in mind that any other commercially available or proprietary application can be used to realize the non-limiting embodiments of the present technology.

Moreover, the information storage medium can store software realizing a web browser. In the general case, the purpose of a web browser is to afford the possibility of the user 142 connecting to the mail server 112 and running the web interface application to use the email service. In the client device 102, the web browser is realized as the browser Safari™. It is important to keep in mind that any other commercially available or proprietary application can be used to realize the non-limiting embodiments of the present technology.

As will be clear to the person skilled in the art, the exchanging of data can occur either by means of the mail client or by means of the web browser and web interface. These technologies are well known in the prior art and for this reason they will not be discussed in particular.

FIG. 1 also shows schematically a client device 104 realized in the form of a personal computer Dell™ Precision T1700 MT CA033PT170011RUWS with processor Intel® Xeon™ processor frequency of: 3300 MHz, with video card nVIDIA™ Quadro K2000, with installed operating system Windows™ 7 Pro 64-bit running on it. On the client device 104 there is installed the mail client Microsoft Outlook. The client device 104 is usually associated with the user 144.

FIG. 1 also shows schematically the client device 106, realized in the form of a notebook HP™ Pavilion™ 15-n001sr with processor AMD A4-Series 1500 MHz Kabini (A4-5000M), main memory of 4096 Mb DDR3-1333 MHz, 15.6″ LED screen with resolution 1366×768 WXGA, video card AMD™ Mobility Radeon HD 8330G, 512+1524 Mb, hard disk 500 Gb (5400 rpm), HDD, connected by lan 10/100, Bluetooth 4.0, WiFi (802.11 b/g/n). As the input device, the client device has a keyboard and Touch Pad. On the client device 106 is installed and running the operating system MS Windows 8 (64-bit). On the client device 108 is installed a web browser, realized as Google Chrome. The client device 106 is usually associated with the user 146.

FIG. 1 also shows schematically the client device 108, realized as a personal computer HP™ Compaq™ Elite 8300 Convertible Minitower PC, with processor Intel™ Core™ i5-3470, clock frequency 3200 MHz, cache memory volume 6 MB, chip set Intel Q77 Express, with main memory of 4096 Mb DDR3 and bus bar frequency 1600 MHz, graphic processor Intel HD Graphics 2500, adapter LAN Ethernet 10/100/1000 Mbit/s. As the input device, the client device 108 has an HP wired keyboard and an HP wired optical mouse. On the client device 108 is installed and running the operating system MS Windows™ 7 Professional 64-bit. On the client device 108 is installed a web browser, which is realized as a Yandex™ browser. The client device 108 is usually associated with the user 148.

As will be clear to the person skilled in the art, the variants of the client devices 102, 104, 106 and 108 are not limited specifically. For example, these client devices can be implemented as: personal computers (desktop computers, notebooks, netbooks, and so on), wireless communication devices (mobile telephones, smartphones, tablets, and so on), as well as network equipment (routers, switches or gateways).

In a given embodiment, a data communication network 110 links each of the client devices—the client device 102, the client device 104, the client device 106 and the client device 108—respectively to a mail server 112, a mail server 114, a mail server 116 and a mail server 118.

The mail server 112 can be an ordinary computer server. In one sample embodiment of the current technology, the mail server 112 can be a server Dell™ PowerEdge™, using the operating system Microsoft™ Windows Server™. Needless to say, the mail server 112 can be any other suitable hardware and/or application software and/or system software or a combination of these. In the embodiment of the current technology that is depicted, without limiting the scope, the mail server 112 is a single server. In other embodiments of the present technology, the functionality of the mail server 112 can be divided up, and it can be embodied as several servers.

The mail server 112 includes an information storage medium (not shown), which can be used by the mail server 112. In principle, this information storage medium can be a storage medium of absolutely any nature and type, including RAM, ROM, disks (compact disks, DVDs, diskettes, hard disks, and so on), USB flash drives, solid state drives, magnetic tape drives, and so on, as well as combinations of these.

The information storage medium of the mail server 112 is intended to store the mail service module (not shown), which includes the mailboxes of the users, including the mailbox of the user 142, the email messages, including the email messages addressed to and/or received by the user 142, and machine-readable instructions enabling the working of the services and the different modules.

A mailbox is part of the disk space allocated to the mail server 112 for storage of the email messages of the user 142, where the mailbox is stored on the indicated portion of the disk space as an ordinary file system directory. The email messages are data files located in the directory of the file system.

Variant embodiments of the mail server 112 are well known in the prior art. Thus, it is enough to mention that the mail server 112 contains, among other things, a network communication interface (not shown) for two-way communications on a data communication network 110; and a processor (not shown), connected to the network communication interface, which is able to carry out different routines, including the ones described below. For this purpose, the processor can store or have access to machine-readable instructions whose execution initiates the processor to execute the various routines described here.

The tasks of the mail server 112 include receiving from the user 142 the email messages intended to be sent, delivering these to the user's mailbox, receiving email messages intended for the user 142, temporary storing of these, and transferring them from the mailbox to the user 142. The mail server 112 can also realize the functions of an intermediate mail server, receiving and forwarding email messages.

FIG. 1 also depicts the mail servers 114, 116 and 118. The mail servers 114, 116 and 118 basically carry out the same functions as the mail server 112. They can be embodied the same as the mail server 112, but also in a different way, enabling them to carry out their functions. Mail servers, their functions and their possible characteristics are well known to the person skilled in the art and therefore shall not be described here. The description of the mail server 112 will allow the person skilled in the art to understand the principles of operation and the functions of the mail servers 114, 116 and 118.

The mail server 112 of the user 142, acting as the sender, interacts with the mail server of the recipient either directly or through an intermediate mail server, or relay 120.

The relay 120 is an outside mail server which receives and forwards email messages. The relay 120 receives email messages for the user's domain and forwards it to the mail servers of the user—either directly or through other relays—as soon as this becomes possible. Despite the fact that the relay 120 in FIG. 1 is shown as a single mail server, the person skilled in the art should understand that in practice an email message can be forwarded in succession through several relays. The relay 120 can be realized in the same way as any of the mail servers 112, 114, 116 and 118, but it can also be realized in a different way.

It should be noted that the mail servers 114, 116 and 118 can also perform the function of the relay 120, when they perform the functions of an intermediate mail server. In just the same way, the mail server 112 can perform the function of the relay 120, when it will be performing the functions of an intermediate mail server. Thus, any mail server can perform the function of the relay 120, and the relay 120 can perform the function of a mail server. For example, in event of sending an email message by the user 142 from the client device 102 to the user 146 on the client device 106, the functions of the relay 120 can be carried out by the mail server 114 and the mail server 118. The functions of the relay 120 can also be carried out by other mail servers not shown in FIG. 1.

To send email messages from a certain sender to a certain recipient one normally uses the SMTP protocol, operating on the client/server principle. On the mail server of a particular recipient the message ends up in a mailbox, from which it goes by a mail delivery agent (MDA) to the user's client. However, for the final delivery of email messages from the mail server of the recipient to the client device of the user, one does not use the SMTP protocol, but generally the POP3 protocol or the IMAP protocol.

The mail service can be realized by any known method. In a given embodiment, the mail service provides its users with services of sending and receiving electronic messages in a distributed (including global) computer network. In the given example, the mail service uses the simple mail transfer protocol, or SMTP, with DNS to obtain the IP address from the host name for sending of the email message and the mail receiving protocol POP3 (Post Office Protocol 3) to receive the email messages.

The mail server 112 is connected to the data communication network 110 by a communication line (not separately numbered). In some non-limiting embodiments of the present technology, the data communication network 110 can be the Internet. In other embodiments of the present technology, the data communication network 110 can be implemented differently—in the form of a global data communication network, a local-area data communication network, a private data communication network, and so on.

The realization of the communication line is not limited, and it will depend on which devices are connected to the data communication network 110. As an example, but not limited to this, the connection of the server 112 to the data communication network 110 can be done on a wireline basis (Ethernet connection).

It is important to keep in mind that the different embodiments of the mail server 112, the client device 102, and the connections to the data communication network 110 are given solely for illustrative purposes. Thus, the person skilled in the art will understand the details of other specific embodiments of the mail servers 112, 114, 116, 118, as well as the details of other embodiments of the client devices 102, 104, 106 and 108, and the communication lines for connection to the data communication network 110. Thus, the examples presented here do not limit the scope of the present technology.

The computer system 100 provides for the sending and receiving of email messages by the users of the email services. Solely for illustration, but not limiting the scope of the present technology, a simplified example will be given below, describing the routine for sending and receiving email messages.

The user 142 from his or her client device 102 connects to the mail server 112 by means of the web interface application. Using the web interface application, the user 142 creates an email message, selects as the addressee (i.e. the user 144), and presses a button to send. There is no need to upload the message to the server, since the email message has already been created on the mail server 112 with the help of the web interface application. Using the computer distributed system for obtaining information about domains DNS (Domain Name System), the mail server 112 obtains data on the mail servers to which it is necessary to send the email intended for the addresses in the domain of the user—the user 144.

Thus, in order to send the email to a particular address, the mail server 112 makes a DNS inquiry, asking for the MX record of the domain of the recipient of the electronic message (that is, the portion of the email address of the user 144 after the symbol “@”). As a result of the inquiry, a list of names of hosts of mail servers receiving incoming mail for the given domain is returned, along with the priority value for each of the hosts. The mail server 112 then tries to establish a SMTP connection to one of these hosts, starting with the one whose priority value is the lowest, sorting through each of them until a connection is successfully established with at least one of them.

But if there are several hosts with identical priorities, attempts are usually made to establish a connection with each of them. Thus, the email message of the user 142 can be sent by the mail server 112 either directly to the mail server 114, which is the mail server of the user 144 (recipient), or through the relay 120, or some other relay.

The mail server 114, having received the email message, verifies whether the mail domain is local for the mail server 114 (that is, whether the mail server 114 is the server of the end recipient of the email message). Since in the given instance the mail server 114 is the mail server of the end recipient of the email message, the email message is received for processing. After the email message ends up at the end mail server (in the given instance, the mail server 114), it performs a temporary or permanent storage of the received email message.

The user 144 runs the mail client Microsoft Outlook on the client device 104. The mail client consults the mail server 114, finds a new email message in the mailbox, and downloads it onto the client device 104.

Next, the user 144 can examine the email message received from the user 142 on the screen (not numbered) of his or her client device 102. This email message received by the user 144 from the user 142 does not contain a citation.

Next, the second user 144 can forward the email message received from the user 142 to the user 146, having added his or her own commentary to the forwarded email message. In order to forward the email message, the user 144 can click with the mouse on the button “Forward”, and add his or her commentary in the window which opens up. The original message is usually automatically included in the composition of the forwarded message (if the user 144 selected this option in the settings). The user 144 then clicks on the button “Send”. Thus, the user 144 sends a new email message to the user 146, which contains the first email message previously sent by the user 142 as a citation.

In response to the clicking with the mouse on the button “Send”, the mail client on the client device 104 is connected to the mail server 114 by using the application level protocol SMTP and transfers to the mail server 114 the data needed to deliver the email message to the user 146.

Using the computer distributed system for obtaining information about domains DNS (Domain Name System), the mail server 114 obtains data on the mail servers to which it is necessary to send the email intended for the addresses in the domain of the user—the user 146. As a result of the inquiry, a list of names of hosts of mail servers receiving incoming mail for the given domain is returned, along with the priority value for each of the hosts. The mail server 112 then tries to establish a SMTP connection to one of these hosts, starting with the one whose priority value is the lowest, sorting through each of them until a connection is successfully established with at least one of them. But if there are several hosts with identical priorities, attempts are usually made to establish a connection with each of them. Thus, the email message of the user 144 can be sent by the mail server 114 either directly to the mail server 116, which is the mail server of the user 146 (recipient), or through the relay 120, or some other relay.

The mail server 116, having received the email message, verifies whether the mail domain is local for the mail server 116 (that is, whether the mail server 116 is the server of the end recipient of the email message). Since in the given instance the mail server 116 is the mail server of the end recipient of the email message, the email message is received for processing. After the email message ends up at the end mail server (in the given instance, the mail server 116), it performs a temporary or permanent storage of the received email message.

The user 146 runs the web browser on the client device 104 and connects to the mail server 116. Using the web interface application which is executed on the mail server 116, the user 142 obtains the email message of the user 144, and has an opportunity to examine it on the screen (not numbered) of the client device 106.

As was already noted above, the email message of the user 144 contains the email message of the user 142 as a citation.

Next, the user 146 can forward the email message received from the user 144 to the user 148, having added his or her own commentary to the forwarded email message. In order to forward the email message, the user 146 can click with the mouse on the button “Forward”, and add his or her commentary. The original message is usually automatically included in the composition of the forwarded message (if the user 146 selected this option in the settings). There is no need to upload the new email message to the mail server 116, since the email message has already been created on the mail server 116 with the help of the web interface application.

The user 146 then clicks on the button “Send”. Thus, the user 146 sends a new email message to the user 148, which contains the email message previously sent to him by the user 144, and the email message previously sent by the user 142 to the user 144, as a citation.

Using the computer distributed system for obtaining information about domains DNS (Domain Name System), the mail server 116 obtains data on the mail servers to which it is necessary to send the email intended for the addresses in the domain of the user—the user 148. As a result of the inquiry, a list of names of hosts of mail servers receiving incoming mail for the given domain is returned, along with the priority value for each of the hosts. The mail server 116 then tries to establish a SMTP connection to one of these hosts, starting with the one whose priority value is the lowest, sorting through each of them until a connection is successfully established with at least one of them. But if there are several hosts with identical priorities, attempts are usually made to establish a connection with each of them. Thus, the email message of the user 146 can be sent by the mail server 116 either directly to the mail server 118, which is the mail server of the user 148 (recipient), or through the relay 120, or some other relay.

The mail server 118, having received the email message, verifies whether the mail domain is local for the mail server 118 (that is, whether the mail server 118 is the server of the end recipient of the email message). Since in the given instance the mail server 118 is the mail server of the end recipient of the email message, the email message is received for processing. After the email message ends up at the end mail server (in the given instance, the mail server 118), it performs a temporary or permanent storage of the received email message.

The user 148 runs the web browser on the client device 104 and connects to the mail server 116. Using the web interface application which is executed on the mail server 116, the user 142 obtains the email message of the user 146.

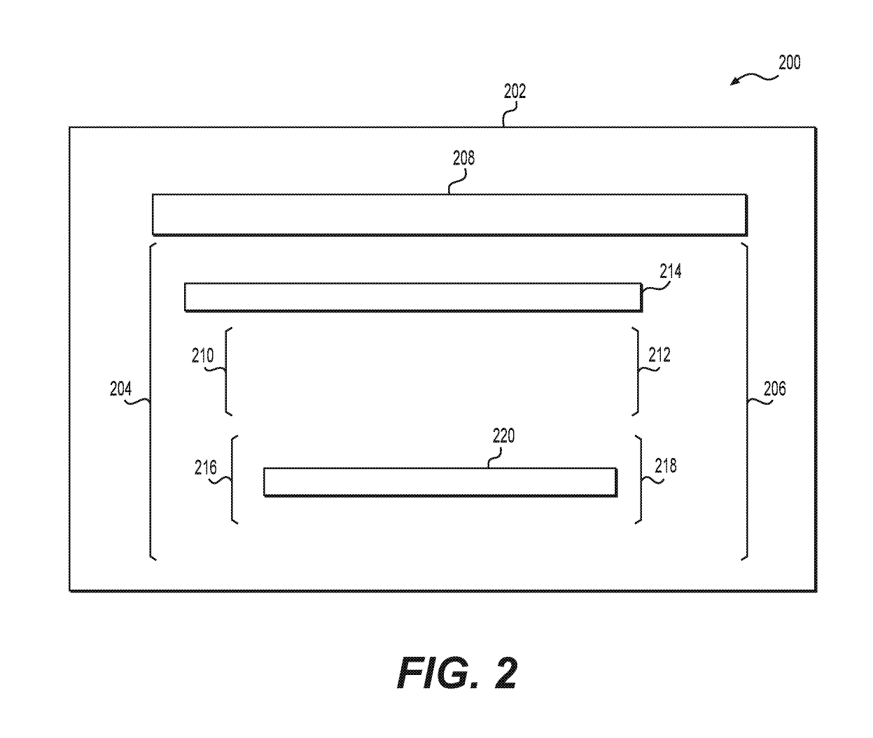

As was already noted above, the email message of the user 146 contains the email message of the user 144 sent to the user 146, and the email message of the user 142 sent to the user 144, as a citation. The structure of this email message sent by the user 146 to the user 148 is shown in FIG. 2, where the indicated message is designated as the email message 200.

Speaking in general, an email message (in the terminology of the SMTP protocol—‘DATA’) can consist of various parts. Thus, it can consist of an email message header and an email message body.

The email message header indicates service information and tags of the mail servers through which the email message has passed, priority tags, an indication of the name and address of the sender and recipient of the email message, the subject of the email message, and other information.

According to the standard, the body of an email message can contain only the symbols of 7-bit ASCII. Therefore, when using national codes and different forms of representation of information (HTML, RTF, images, binary file attachments), the body of the email message should be coded by the MIME standard and cannot be read by a person without the use of a decoder or a mail client with such a decoder.

The email message header is described by various standards, including the standards RFC 2076—Common Internet Message Headers, and it includes information from other RFCs: RFC 822, RFC 1036, RFC 1123, RFC 1327, RFC 1496, RFC 1521, RFC 1766, RFC 1806, RFC 1864, RFC 1911), as well as RFC 4021—Registration of Mail and MIME Header Fields.

The email message header is usually separated from the email message body by an empty line. The email message header usually indicates the mail servers through which the email message has passed (each mail server adds information on whom this email message was received from), information as to whether this email message is similar to spam, information on the verification of authenticity, and the level of urgency of the email message (which can be changed by the mail servers).

The email message header also usually notes the program used to create the email message. Such information is indicated in the header in the form of records. Since the headers of email messages are service information, most often the mail clients conceal them from the user during ordinary reading of the email message, but also afford the possibility of seeing these headers if there is a need for more detailed analysis of the email message. If the email message is converted from SMTP format to another format (such as Microsoft Exchange 2007 email messages are converted into MAPI), the email message header is saved separately, to enable diagnostics.

Records in the email message header are usually added from bottom to top (that is, each time it is necessary to add a record to the message, it is added to the first line, before all previous ones).

Besides service information, the email message header can also save information which can be shown to the user, usually the sender of the email message, the recipient, the subject and the date of sending.

FIG. 2 shows a schematic representation of the structure of the email message 200.

The email message 200 shown schematically in FIG. 2, as already mentioned above, is an email message which includes two citations, constituting two consecutively forwarded email messages and embedded in the email message 200.

The structure of the email message 200 is shown in FIG. 2 by an illustration of the structure of the source code 202 of the email message 200. The source code 202 of the email message 200 includes the header 208 of the email message 200 and the body (not shown) of the email message 200.

The header 208 of the email message 200 can contain information concerning the sender, the recipients, and other information. The exact content of the email message header differs according to the email system formulating the message. As an example, the header contains the following data elements: the subject of the message, the sender, the date of receipt of the message, the return address, the recipient, the email address of the recipient, the attachments, and other items.

The “subject” data element contains a description of the subject of the message, which is displayed in the majority of email systems with individual display of messages. The subject might be “Your order is filled”, “Your bank eStatement is ready”, “Shall we go to dinner today to the 10th floor?”, “Your application has been filed at Portal No. 123456”, “The 5 to 7 has started”, and so on.

The “sender” data element contains the email address of the sender. Usually it is also a return address, unless a different email address is indicated. The “sender” data element can have the following form:
From: Mary Example <mary.example@gmail.com>

The “date” data element is information about the date of receipt of the message. The data can be presented in different formats. For example, 4 July 2014 can be presented as “Fri, 4 Jul 2014”, “Friday, July 4 2014”, “04/06/2014”, “06/04/2014”, “4.06.14”, and so on.

The “time” data element is information about the time of receipt of the message and the time zone. For example, 15 hours 40 minutes 46 seconds Eastern Standard Time (USA and Canada) can be represented as: “12:40:46-0700”, “12.40.46”, “15:40:46-0400”, and so on.

The “time” and “date” data elements can be represented together as a single record, for example, as
X-OriginalArrivalTime: 19 Sep 2014 19:40:47.0226 (UTC) FILETIME=[9C0045A0:01CFD441]

The “return address” data element is information about the email address to which the answer will be sent upon pressing the “Reply” button. For example, this record may have the form: Return-Path: <mary.example@gmail.com>

The “recipient” data element contains information about the name of the recipient of the email in accordance with the email settings of the sender of the email message.

The “recipient email address” data element contains the email address of the recipient or the address to which the message was actually sent. This data element can be presented by a record of the type: To: “John Example”<johnexample@hotmail.com>

The code of the email message header can be written in xml format. Headers may include not only data pertaining to the email message 200, but also certain data pertaining to one or more messages included in the email message 200 as citations. This can occur due to the fact that when a message is forwarded, additional headers may be added to the headers.

The body of the email message 200 (not shown) usually contains text, which is the primary content of an email message. The body of an email message 200 can also contain signatures or automatically generated text, added by the email system of the sender.

The code of the body of a message can be written in HTML, language. HTML, is a tag language for markup of documents, that is, any document in HTML language is a set of elements, where the beginning and end of each element is designated by special markers, known as tags. The register in which the name of the tag is composed has no significance in HTML. Elements can be empty, that is, not containing any text or other data (for example, the line break tag <br>). In this case, the closing tag is usually not indicated. Furthermore, elements can have attributes, defining certain of their properties (such as font size for the tag <font>).

The body of the email message 200 opens with an opening tag 204 and closes with a closing tag 206. The content of the message is found between the opening tag 204 and the closing tag 206. Between the opening and closing tag, other openings and closings tags may be found. For example, there can be tags designating text blocks and the like, such as: <H1> . . . </H1>, <H2> . . . </H2>, . . . , <H9> . . . </H9>—headers of level 1, 2, . . . 9; <P>—a new paragraph, where the closing tag at the end of the paragraph </P> is not mandatory.

One type of tag are the opening and closing tags which are used to isolate quotations: <BLOCKQUOTE> . . . <BLOCKQUOTE>. Since the email message 200 contains two email messages as citations, the HTML code of the email message 200 will contain two pairs of tags <BLOCKQUOTE> . . . <BLOCKQUOTE>, namely, the opening tag 210 of the citation of the second forwarded message, the closing tag 212 of the citation of the second forwarded message, the opening tag 216 of the citation of the first forwarded message, and the closing tag 218 of the citation of the first forwarded message.

The opening tag 210 of the citation of the second forwarded message signals the start of the citation which is the second forwarded email message, and the closing tag 212 of the citation of the second forwarded message signals the end of the citation which is the second forwarded email message.

The opening tag 216 of the citation of the first forwarded message signals the start of the citation which is the first forwarded email message, and the closing tag 218 of the citation of the first forwarded message signals the end of the citation which is the first forwarded email message.

When forwarding email messages, some data from the headers of the email message which is being forwarded might appear in the body of the forwarded email message. Accordingly, if the message is forwarded several times in succession, with or without adding commentary, the final message may contain in the message body data on several messages that is usually found in the header (such as the names of the senders and recipients of the previous messages, the date and time of sending, the subjects of the messages).

As an illustration, within the body of an email message 200, that is between the opening tag 204 and the closing tag 206, there is situated data containing information about a second email message. This data constitutes a second header 214 of a second citation. It may be noted that the second header 214 of the second citation is located before the opening tag 210 of the citation of the second forwarded email message.

Within the body of the email message 200, that is between the opening tag 204 and the closing tag 206, there is also situated data containing information about a first email message, constituting a first header 220 of a first citation. It may be noted that the first header 220 of the first citation is located in the given example after the opening tag 216 of the citation of the first forwarded email message and the closing tag 218 of the citation of the first forwarded message.

As an example of what kind of information about email messages can be found in the body of an email message we present a fragment of HTML code of a forwarded email message. In the given example, the first user Mary Example has written a message to John Example, and John Example has responded to the message of Mary Example. The following fragment of HTML code constitutes a fragment of the HTML code of the second message, while the second message contains the first message in its entirety as a citation:

<html><head><meta http-equiv=3D“content-type” content=3D“text/html; charset=3D=
utf-8”></head><body dir=3D“auto”><div><br><br><div>-------------------------=
-----</div>Thanks, fine! Sent from my iPhone wireless
device<div><br></div></div><div><br>=
Begin forwarded message:<br><br></div><blockquote type=3D“cite”><div><b>From:=
</b> John Example &lt;<a
href=3D“mailto:johnexample@hotmail.com”>johnexample@hot=
mail.com</a>&gt;<br><b>Date:</b> September 19, 2014 at 15:35:02 EDT<br><b>To=
:</b> “<a
href=3D“mailto:mary.example@gmail.com”>mary.example@gmail.com</a>”=
&lt;<a
href=3D“mailto:mary.example@gmail.com”>mary.example@gmail.com</a>&gt=
;<br><b>Subject:</b> <b>Hi Mary</b><br><br></div></blockquote>=
<blockquote type=3D“cite”><div><span>Mary, </span><br><span></span><br><span=
></span><br><span>How are you doing?. &nbsp;=
&nbsp; &nbsp; &nbsp; &nbsp; &nbsp; &nbsp; &nbsp;&nbsp; &nbsp; &nbsp; &nbsp=
; &nbsp; &nbsp;</span></div></blockquote></body></html>=

As can be seen from the fragment of HTML code presented above, the body of the message contains not only the actual correspondence (“How are you doing?” “Thanks, fine! Sent from my iPhone wireless device”), but also the name of the first sender (John Example), the email address of the first sender (johnexample@hotmail.com), the date of the first message (September 19, 2014) and the time of sending of the first message (15:35:02 EDT). The body of the email message in the given example also has the email address (mary.example@gmail.com) of the recipient of the first email message. Thus, all of the aforementioned data is located between the opening tag 204 and closing tag 206.

This data which is present in the body of the forwarded message may be absent from the header of the second message, which contains the first message. Thus, the data contained in the body of the forwarded messages can serve as a source of data on the names, the electronic addresses of the previous senders, the time and dates of sending of the previous messages.

The exact disposition of the second header 214 of the second citation and of the first header 220 of the second citation will differ depending on the email system used to compose the message of the second and first email message, respectively.

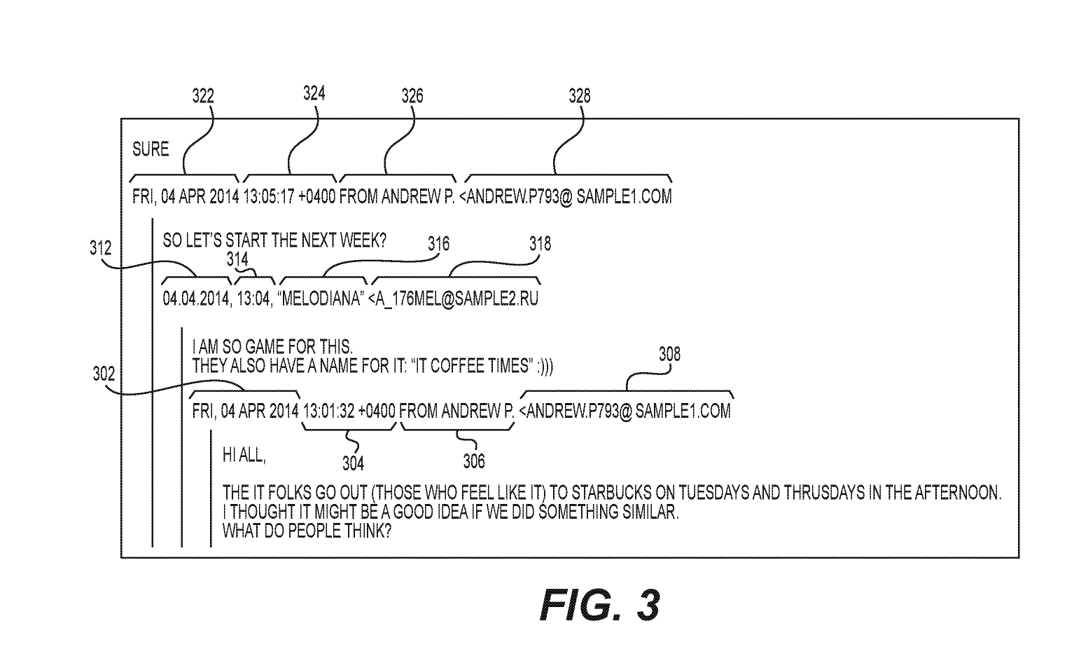

FIG. 3 is a graphic representation of an email message whose body contains three citations on the display of a client device 108 (of the existing prior art).

In this nonlimiting example, the message constitutes a fourth email message which is the result of the electronic correspondence of the users 144 and 148.

For greater clarity, the steps of the correspondence are presented below.

First email message, sent by the user 148 to the user 144, not containing a citation.

The user 148 sends from the client device 108 to the user 144 on the client device 104 a first email message of the following content: “Hi all, The IT folks go out (those who feel like it) to Starbucks on Tuesdays and Thursdays in the afternoon. I thought it might be a good idea if we did something similar. What do people think?”.

This message was sent on Friday, 4 April 2014 (the message sending date 302) at 13 hours 1 minute 32 seconds Moscow time (the message sending time 304). In the lines of his email, the user 148 indicated his name as “Andrew P.” (the sender's name 306) and sent the email message andrew.p793@sample1.com from his email address (sender's email address 308).

Second email message sent in reply by the user 144 to the user 148, containing one citation.

The user 144 receives on the client device 104 this first email message.

The visual representation of this first email message on the display of the client device 104 includes not only the text written by the user 148, but also some data which the client device 104 extracted from the header of the first email message of the user 148, namely, the message sending date 302, the message sending time 304, the sender's name 306, and the sender's email address 308.

In reply, the user 144 sends from his client device 104 to the user 148 on the client device 108 a second email message, having written the text: “I am so game for this. They also have a name for it: ‘IT coffee times’:)))” and having clicked on the button “Send”.

The mail client has automatically included in the body of the second email message, as a citation, the first email message received by the user 144 from the user 148. The mail client has also included in the body of the second email message information extracted by the client device 104 from the header of the first email message, namely, the message sending date 302, the message sending time 304, the sender's name 306, and the sender's email address 308.

However, all of this data, as well as the text “Hi all, The IT folks go out (those who feel like it) to Starbucks on Tuesdays and Thursdays in the afternoon. I thought it might be a good idea if we did something similar. What do people think?”, is now forwarded in the body of the email message of the user 144 as a citation, and not in the header of the email message of the user 144. The data concerning the message sending date 302, the message sending time 304, the sender's name 306, and the sender's email address 308 are elements of the header of the citation.

Third email message sent in reply by the user 148 to the user 144, containing two citations.

The user 148 receives on the client device 108 in reply from the user 144 and the client device 144 a second email message. The second email message contains, as a citation, the first message of the user 148, and also information which is now the header of the citation of the first email message (the message sending date 302), (the message sending time 304), (the sender's name 306), and (the sender's email address 308).

The representation of this first email message on the display of the client device 108 includes not only the representation of the text of the received second email message, but also some data which the client device 108 has extracted from the header of the second email message of the user 144, namely: the message sending date 312, the message sending time 314, the sender's name 316, and the sender's email address 318.

The user 148 sends from his client device 108 in reply to the user 144 on the client device 104 the third email message, having written the text: “So let's start the next week?” and having clicked on the “Send” button in his web interface.

The mail client has automatically included in the body of the third email message, as a citation, the first email message, sent by the user 148 to the user 144, and the second email message, sent in reply by the user 144 to the user 148. The reply also includes information previously extracted by the client device 104 from the header of the first email message, namely, the message sending date 302, the message sending time 304, the sender's name 306, and the sender's email address 308, and the email messages forwarded afterwards in the body of the email message. Moreover, the reply automatically includes information extracted by the client device 108 from the header of the second email message, namely, the message sending date 312, the message sending time 314, the sender's name 316, and the sender's email address 318.

Since the headers of the first email message and the headers of the second email message have been extracted by different client devices using different programs, the visual representation of the data of the same kind is not unified. For example, the message sending date 302 and the message sending date 312, the message sending time 304 and the message sending time 314, the sender's name 306 and the sender's name 316 are written in different formats. Only the sender's email address 308 and the sender's email address 318 are presented uniformly.

These examples show the principle of including information from the header of one email message in the body of another email message when the first email message is forwarded (for example, by pressing the “Send” or “Forward” buttons).

Fourth email message sent in reply by the user 144 to the user 148, and represented on the display of the user 148, containing three citations.

The user 144 receives on the client device 104 in reply from the user 148 on the client device 108 the third email message. The third email message contains, as a citation, the first message of the user 148, as well as information which is now the header of the citation of the first email message (the message sending date 302), (the message sending time 304), (the sender's name 306), and (the sender's email address 308).

The third email message also contains as a citation the second message of the user 144, as well as information which is the header of the citation of the second email message (the message sending date 312), (the message sending time 314), (the sender's name 316), and (the sender's email address 318).

The representation of this third email message on the display of the client device 104 includes not only the representation of the text corresponding to the body of the received third email message, but also some data which the client device 104 has extracted from the header of the third email message of the user 148, namely: the message sending date 322, the message sending time 324, the sender's name 326, and the sender's email address 328.

The user 144 sends from his client device 104 in reply to the user 148 on the client device 108 the fourth email message, having written the text: “Sure” and having clicked on the “Send” button in his web interface.

The mail client has automatically included in the body of the fourth email message, as a citation, the first email message, sent by the user 148 to the user 144, the second email message, sent in reply by the user 144 to the user 148, and the third email message, sent by the user 148 to the user 144. The reply also includes information previously extracted by the client devices 104 and 108 from the headers of the email messages received.

The examples presented show the principle of including information from the header of a first email message in the body of a second email message when the first email message is forwarded (for example, by pressing the “Send” or “Forward” buttons).

Since the headers of the first email message and the headers of the third email message have been extracted by the same client device 108 using the identical web interface, the visual representation of data of the same kind is uniform. For example, the message sending date 302 and the message sending data 322, the message sending time 304 and the message sending time 324, the sender's name 306 and the sender's name 326, and the sender's email address 308 and the sender's email address 328 are visually represented in the same format.

However, since the headers of the first email message and the third email message, on the one hand, and the headers of the second email message on the other hand were extracted by different client devices, using different programs, the visual presentation of data of the same kind is not uniform. For example, the message sending date 302 and the message sending data 312, the message sending time 304 and the message sending time 314, the sender's name 306 and the sender's name 316 are visually presented in different formats. Only the sender's email address 308 and the sender's email address 318 are presented uniformly.

Thus, the existing prior art does not ensure uniformity of representation of the data of the same kind that are elements of the headers of the citations.

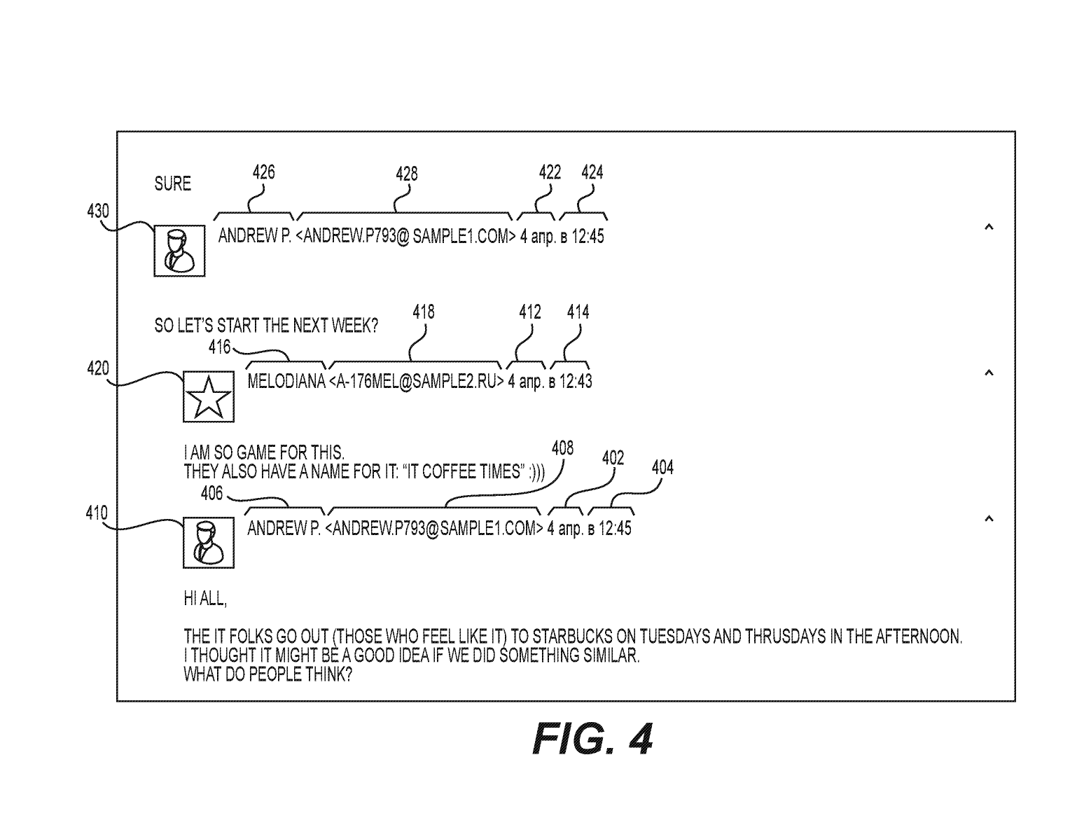

FIG. 4 is a graphic representation of an email message formatted in accordance with one of the embodiments of the present technology, whose body contains three citations.

In this nonlimiting example, the email message, like FIG. 3, constitutes a fourth email message which is the result of the electronic correspondence of the users 144 and 148.

The steps of the correspondence are analogous to the steps of the correspondence described above to explain FIG. 3.

As can be seen from FIG. 4, in this nonlimiting embodiment of the present technology the visual presentation of all data of the same kind is uniform.

Thus, the message sending date 402, the message sending date 412, and the message sending date 422 are visually presented in uniform format.

The message sending time 404, the message sending time 414, and the message sending time 424 are visually presented in uniform format.

The sender's name 406, the sender's name 416, and the sender's name 426 are visually presented in uniform format.

The sender's email address 408, the sender's email address 418, and the sender's email address 428 are visually presented in uniform format.

The uniform visual presentation is ensured even though the users 144 and 148 employed client devices of different type and software of different type.

The method for computer processing of email messages and visual presentation, in the body of the email message, of citations which constitute a sequence of content of a first forwarded email message and content of a second forwarded email message, which method ensures a uniform presentation, shall be explained below by means of the block diagram of the method 500.

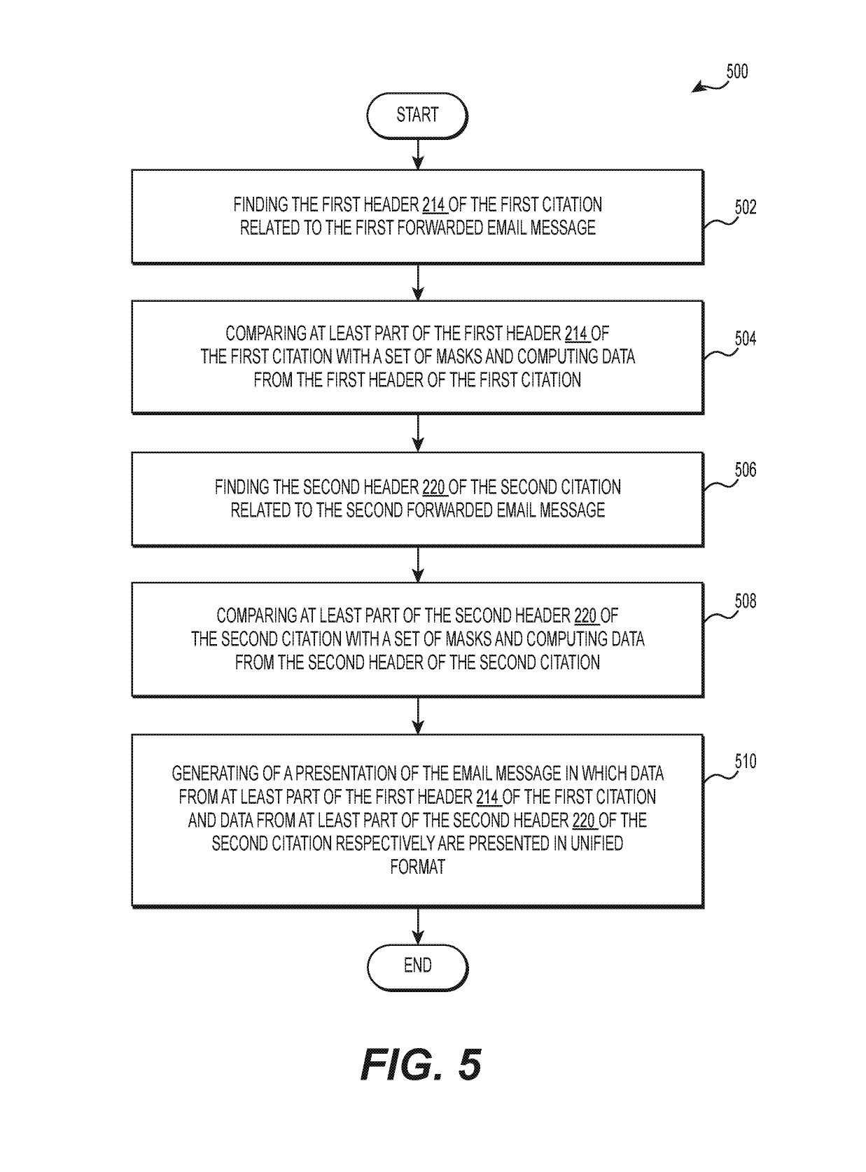

FIG. 5 is a block diagram of the method 500, which is carried out on the server 118, shown in FIG. 1, and carried out in accordance with variant embodiments of the present technology.

In variant embodiments of the present technology, the method 500 can be carried out on the server 118 shown in FIG. 1. For this, the server 118 includes an information storage medium, which saves machine-readable instructions, upon execution of which the server 118 carries out the steps of the method 500. For a better understanding of the method 500, references will also be made to FIG. 2, the schematic representation of the structure of an email message 100.

In the given embodiment of the present technology which is described in the block diagram 500, the first citation was sent as a first email message using a first mail service, and the second citation was sent as a second email message using a second mail service. Which mail service was actually used by one user or the other is not important. For example, it can be any of the mail services Yandex™ mail, Google™ mail, Yahoo!™ mail, and so on.

Moreover, the first citation was sent with the use of a mail client, and the second citation was sent with the aid of a web interface. Which mail client was actually used is not important.

Step 502—finding the first header 220 of the first citation related to the first forwarded email message.

The method 500 starts in step 502, when the mail server 118 shown in FIG. 1 finds the first header 220 of the first citation related to the first forwarded email message. As can be seen in FIG. 2, the first citation having the earliest sending date is found at the very end of the email message 100.

In this embodiment of the present technology, the finding of the first header 220 of the first citation related to the first forwarded email message is done by analysis of the source code of the email message 100.

The mail server 118 can receive the source code of the email message 100 beforehand by the data communication network 110 or directly from the mail server of the sender of the email message 100, or via a relay.

In some embodiments of the present technology, the email message 100, where the source code has an html markup, the analysis of the source code of the email message 100 may involve first finding the HTML tags which describe the citations.

In some embodiments of the present technology, the finding of the HTML tags describing the citations may include finding the HTML tag pertaining to the first citation, and the finding of the HTML tag relating to the second citation. Such tags can be the opening and closing HTML tags, such as <blockquote> and </blockquote>. In FIG. 2 these HTML, tags are shown as the opening tag 216 of the citation of the first forwarded message and the closing tag 218 of the citation of the first forwarded message.

It is possible to determine which citation a particular HTML tag refers to with the help of analysis of the sequence of opening and closing HTML tags.

In the given embodiment of the present technology, the finding of the first header of the first citation related to the first forwarded email message can be done by comparing the fragments of HTML code adjacent to the HTML tags related to the first citation with a set of masks, and identifying the corresponding fragment of HTML code as the first header of the first citation.

The method 500 then moves on to step 504.

Step 504—comparing at least part of the first header 220 of the first citation with a set of masks and determining data from the first header of the first citation.

In step 504, the server 118 compares at least part of the first header 220 of the first citation with a set of masks and computes data from the first header 220 of the first citation.

The determining of data from at least part of the first header 220 of the first citation can further include determining of data from the first fragment of HTML code directly adjacent to the first HTML tag related to the first citation. The first fragment of HTML code directly adjacent to the first HTML tag related to the first citation may include at least one of: the part of HTML code directly preceding the first HTML tag related to the first citation and the part of HTML code directly following the HTML tag related to the first citation.

In other words, the searching and the determining of data is done from the fragments of HTML code located in proximity to the opening and closing tags of the first citation, that is, such fragments for searching are potentially the fragment located immediately before the opening tab 216 of the citation of the first forwarded email message, immediately after the closing tag 218 of the citation of the first forwarded email message, and between the opening tag 216 of the citation of the first forwarded email message and the closing tag 218 of the citation of the first forwarded email message.

As can be seen from this example, such an analysis shows that the sought fragment is located between the opening tag 216 of the citation of the first forwarded email message and the closing tag 218 of the citation of the first forwarded email message.

In some embodiments of the present technology, the limit for search and analysis can be bounded by a maximum distance from the opening and closing tags equal to four lines.

The first header 220 of the first citation is then compared with the set of masks. The sets of masks may include subsets which are used to determine the message sending date, the message sending time, the sender's name, and the email address of the sender.

For example, the subset of masks for determining the message sending date and time may include a group of masks for identifying data as to the date and time of sending of the email messages which are presented in different formats. The mail server 118 then computes and date and time from at least part of the first header 220 of the first citation.

The subset of masks for determining the name may contain a database of common first and last names for comparison. Furthermore, the name can be computed by accessing the address book of the recipient of the email message 100 (in the present case, the user 148) for comparison of the code fragment with the names of contacts. The mail server 118 then computes the sender's name from at least part of the first header 220 of the first citation.

Methods of identification and determining of an email address are known to persons skilled in the art.

The method 500 then moves on to step 506.

Step 506—finding the second header 220 of the second citation related to the second forwarded email message.

In step 506, the mail server 118 shown in FIG. 1 finds the second header 214 of the second citation related to the second forwarded email message.

The finding of the second header 214 of the second citation related to the second forwarded email message is done the same as the finding of the first header 220 of the second citation related to the first forwarded email message, as was described in step 502.

The method 500 then moves on to step 508.

Step 508—comparing at least part of the second header 214 of the second citation with a set of masks and determining data from the second header of the second citation.

In step 508, the mail server 118 shown in FIG. 1 compares at least part of the second header 214 of the second citation with a set of masks and computes data from the second header of the second citation. The routine is carried out the same as the comparing of at least part of the first header 220 of the first citation with the set of masks and the determining of data from the first header of the first citation (step 504), and to avoid repetition it will not be presented here.

The method 500 then moves on to step 510.

Step 510—generating of a presentation of the email message in which data from at least part of the first header 220 of the first citation and data from at least part of the second header 114 of the second citation are presented in unified format.

In step 510, the server 118 converts the data extracted from at least part of the first header 220 of the first citation and from at least part of the second header 214 of the second citation into a unified format for a unified presentation to the user 148.

In addition (or optionally), the mail server 118 can search for avatars of the users 144 and 148 and can include these in unified form in the email message. The method for finding avatars is known to the person skilled in the art and therefore will not be explained. An example of a unified presentation of avatars in an email message is shown in FIG. 4, items 410, 420 and 430, where all the avatars have been placed at the start of the citation and have an identical size. The avatar of the same user is identical in all the citations (items 410 and 430).

In some embodiments of the present technology, the method 500 further involves: finding the first header of the email message; determining data from the first header of the email message; generating a presentation of the email message in which data from the header of the email message, data from at least part of the first header of a first citation, and data from at least part of a second header of a second citation are presented in the unified format. In other words, not only the data obtained from the headers of the citations 214 and 220, but also the data obtained from the header of the email message 100 is placed in a unified format of visual presentation.

The method 500 then ends.

In the context of the present specification it should be understood that wherever it talks of obtaining data from a particular client device and/or a particular mail server and/or any other server, one can make use of the obtaining of an electronic or other signal from the corresponding client device (server, mail server), while the displaying on the screen of the device can be realized as a sending of a signal to the screen that contains definite information which can be interpreted afterwards by defined forms and at least partly displayed on the screen of the client device. The sending and receiving of the signal are not everywhere indicated in the body of the present specification in order to simplify the exposition and facilitate the understanding of the present solution. The signals may be transmitted by optical methods (by a fiber-optic network, for example), by electronic methods (wireline or wireless), or mechanical methods (transmission of pressure, temperature and/or other physical parameters by which a signal can be transmitted).

1. A method for computer processing of email messages and visual presentation in the body of the email message of citations constituting a sequence of content of a first forwarded email message and the content of a second forwarded email message, the method comprising:
(i) finding a first header of a first citation associated with the forwarded first email message;
(ii) comparing at least part of the first header of the first citation with a set of masks to determine first data from the first header of the first citation;
(iii) finding a second header of a second citation associated with a forwarded second email message;
(iv) comparing at least part of the second header of the second citation with a set of masks to determine second data from the second header of the second citation;
(v) transforming at least a portion of the first data and at least a portion of the second data for presentation in a unified format of presentation;
(vi) reformatting the body of the email message of citations to include the transformed at least a portion of the first data and at least a portion of the second data for presentation in the unified format of presentation.

2. The method according to claim 1, further comprising obtaining an email message source code.

3. The method according to claim 2, wherein the email message source code has an html markup, the method further comprising (i) finding the first HTML tags describing the first citation, and (ii) finding the second HTML tags describing the second citation.

4. The method according to claim 1, wherein:
(i) the determining of the first data from at least part of the first header of the first citation further comprises determining the first email address;
(ii) the determining of the second data from at least part of the second header of the second citation further comprises determining the second email address.

5. The method according to claim 1, wherein:
(i) the determining of the first data from at least part of the first header of the first citation further comprises determining the date of sending of the first email message;
(ii) the determining of the second data from at least part of the second header of the second citation further comprises determining the date of sending of the second email message.

6. The method according to claim 1, wherein:
(i) the determining of the first data from at least part of the first header of the first citation further comprises determining the time of sending of the first email message;
(ii) the determining of the second data from at least part of the second header of the second citation further comprises determining the time of sending of the second email message.

7. The method according to claim 1, wherein:
(i) the determining of the first data from at least part of the first header of the first citation further comprises determining the name of the sender of the first email message;
(ii) the determining of the second data from at least part of the second header of the second citation further comprises determining the name of the sender of the second email message.

8. The method according to claim 3, wherein the determining of the first data from at least part of the first header of the first citation further comprises determining the data from the first fragment of HTML code immediately adjacent to the first HTML tag pertaining to the first citation, and the determining of the second data from the second header of the second citation further comprises determining data from the second fragment of HTML code immediately adjacent to the second HTML tag pertaining to the second citation.

9. The method according to claim 8, wherein:
(i) the first fragment of HTML code immediately adjacent to the first HTML tag pertaining to the first citation includes at least one of: a portion of HTML code immediately preceding the first HTML tag pertaining to the first citation, and a portion of HTML code immediately following the first HTML tag pertaining to the first citation, and
(ii) the second fragment of HTML code immediately adjacent to the second HTML tag pertaining to the second citation includes at least one of: a portion of HTML code immediately preceding the second HTML tag pertaining to the second citation, and a portion of HTML code immediately following the second HTML tag pertaining to the second citation.

10. The method according to claim 9, wherein:
(i) the portions of HTML code immediately preceding, respectively, one of: the HTML tag pertaining to the first citation and the HTML tag pertaining to the second citation, are situated at a distance of within four lines from the opening HTML tags of, respectively, the first header of the first citation and the second header of the second citation, and where
(ii) the portions of HTML code immediately following, respectively, one of: the HTML tag pertaining to the first citation and the HTML tag pertaining to the second citation, are situated at a distance of within four lines from the opening HTML tags of, respectively, the first header of the first citation and the second header of the second citation.

11. The method according to claim 1, wherein the first citation has been sent as a first email message with the use of a first mail service, and the second citation has been sent as a second email message with the use of a second mail service.

12. The method according to claim 1, wherein the first citation has been sent as a first email message with the use of a first web browser, and the second citation has been sent as a second email message with the use of a second web browser.

13. The method according to claim 1, wherein the first citation has been sent as a first email message with the use of a first mail client, and the second citation has been sent as a second email message with the use of a second mail client.

14. The method according to claim 1, further comprising obtaining a first avatar of the author of the first citation and a second avatar of the author of the second citation, and including the first avatar and the second avatar in the unified format in the body of the email message.

15. The method according to claim 1, further comprising
(i) finding the first email message header;
(ii) determining the first data from the first email message header;
(iii) forming a presentation of the email message, in which data from the email message header, the first data from at least part of the first header of the first citation, and the second data from at least part of the second header of the second citation are presented in the unified format.

16. A computer, comprising a processor, where the processor is configured to:
(i) find a first header of a first citation associated with a forwarded first email message;
(ii) compare at least a portion of the first header of the first citation with a set of masks to determine first data from the first header of the first citation;
(iii) find a second header of a second citation associated with a forwarded second email message;
(iv) compare at least a portion of the second header of the second citation with a set of masks to determine second data from the second header of the second citation;
(v) transform at least a portion of the first data and at least a portion of the second data for presentation in a unified format of presentation;
(vi) reformat the body of the email message of citations to include the transformed at least a portion of the first data and at least a portion of the second data for presentation in the unified format of presentation.

17. Computer according to claim 16, wherein the processor is further configured to obtain an email message source code.

18. Computer according to claim 17, wherein the source code of the email message has an html markup, and wherein the processor is further configured to find the first HTML tags describing the first citation and the second HTML tags describing the second citation.

19. Computer according to claim 16, wherein:
(i) the determining of the first data from at least part of the first header of the first citation further comprises determining the first email address;
(ii) the determining of the second data from at least part of the second header of the second citation further comprises determining the second email address.

20. Computer according to claim 16, wherein:
(i) the determining of the first data from at least part of the first header of the first citation further comprises determining the date of sending of the first email message;
(ii) the determining of the second data from at least part of the second header of the second citation further comprises determining the date of sending of the second email message.

21-30. (canceled)
